(19) United States
(12) Patent Application Publication
(10) Pub. No.: US 2005/0260972 A1
(43) Pub. Date: Nov. 24, 2005

(54) Enabling and controlling access to wireless hot spots

(75) Inventors: Jeyhan Karaoguz, Irvine, CA (US); Nambi Seshadri, Irvine, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Broadcom Corporation

(21) Appl. No.: 11/099,457

(22) Filed: Apr. 6, 2005

Related U.S. Application Data
(63) Continuation of application No. 10/327,079, filed on Dec. 24, 2002.
(60) Provisional application No. 60/409,935, filed on Sep. 12, 2002.

(51) Int. Cl. H04M 11/00

(52) U.S. Cl. 455/406; 455/405

(57) ABSTRACT

A process of enabling and controlling access to a wireless hotspot by a wireless portable device is disclosed. An access request is sent, seeking access to a wireless hotspot, to an authenticating entity and response to the access request is awaited. Additional verification information is provided when requested by the wireless hotspot and wireless network data is exchanging between the wireless portable device and the wireless hotspot. Additionally, the access request includes an identifier used by the authenticating entity to authenticate the wireless portable device.

### REFERENCE TO RELATED APPLICATIONS

This application is a continuation of U.S. application Ser. No. 10/327,079, filed Dec. 24, 2002, entitled, “Enabling and Controlling Access to Wireless Hot Spots,” which claims priority of U.S. Provisional Application Ser. No. 60/409,935, filed Sep. 12, 2002, the entire contents of which are incorporated herein by reference.

### BACKGROUND OF THE INVENTION

1. Field of Invention

The present invention relates to devices and networks that utilize wireless computer networks and methods of enabling and controlling access of a wireless portable device to a wireless computer network. The present invention further relates to methods, devices and networks that allow wireless hotspots to enable or disable access to the wireless hotspots by wireless portable devices. Additionally, the present invention also provides a way for the wireless hotspot to control the access and authorization process based on several factors.

2. Description of Related Art

The emergence of what are commonly called wireless hotspots has increased the mobility of wireless users and allowed expanded coverage of access for users in many locations. Many of these wireless hotspots have appeared in different locations, such as coffee shops and libraries, and allow users with wireless communication equipment to communicate with local area networks and wide area networks as they move about. The locations that provide the access do so to attract customers or, in the case of public libraries, because they see such access as an extension of their public interest. However, enabling and controlling access to the hotspots is a burden that is placed on the proprietors of the hotspots.

Many of the hotspot locations are run by small establishments and do not have the ability to restrict the use of the hotspot without detracting from their main businesses. Controlling and enabling of access to the hotspot could require, among other things, that the proprietors issue passwords, oversee usage, etc., in addition to paying for the service. Such issues also arise for larger establishments that provide hotspots.

As such, there is a need for a method or mechanism that can effectuate or enhance the process of accessing a wireless hotspot by a wireless device. In addition, there is also a need for a method or mechanism that can simplify the process of allowing access.

### SUMMARY OF THE INVENTION

This invention seeks to overcome the drawbacks of the above-described conventional network devices and methods. The present invention is directed to methods that allow for wireless portable devices to access a wireless hotspot. The present invention also allows for multiple procedures for gaining access to the wireless hotspots to allow for the greatest number of potential users to seek access.

According to one aspect of this invention, a process of enabling and controlling access to a wireless hotspot by a wireless portable device is disclosed. An access request is sent, seeking access to a wireless hotspot, to an authenticating entity and response to the access request is awaited. Additional verification information is provided when requested by the wireless hotspot and wireless network data is exchanging between the wireless portable device and the wireless hotspot. Additionally, the access request includes an identifier used by the authenticating entity to authenticate the wireless portable device.

Alternatively, information about the wireless hotspot may be received through an advertisement sent from one of the wireless hotspot and the authenticating party. Also, the process may include receiving a periodic contact from the authenticating entity to verify continued access to the wireless hotspot and responding to the periodic contact based on whether the wireless portable device is still accessing the wireless hotspot.

The process may include that the access request may be sent to a wireless telephone service provider, a landline telephone service provider or the wireless hotspot. The requested data from the wireless hotspot may be indicative of at least one of a number of users of the wireless hotspot and an expected bandwidth for an additional user of the wireless hotspot.

According to another embodiment of this invention, a process of enabling and controlling access to a wireless hotspot by a wireless portable device is disclosed. The process includes receiving an access request, seeking access to a wireless hotspot, from an access seeking entity, where the access request includes an identifier used to authenticate the wireless portable device, checking the identifier against a database of authorized identifiers and sending authorization data to the access seeking entity when the identifier is found in the database.

In another embodiment, a system for enabling and controlling access to a wireless hotspot by a wireless portable device is disclosed. The system includes sending means for sending an access request, seeking access to a wireless hotspot, to an authenticating entity, timing means for awaiting response to the access request, providing means for providing additional verification information when requested by the wireless hotspot and exchanging means for exchanging wireless network data between the wireless portable device and the wireless hotspot. Additionally, the access request includes an identifier used by the authenticating entity to authenticate the wireless portable device.

In another embodiment, a system for enabling and controlling access to a wireless hotspot by a wireless portable device id disclosed. The system includes receiving means for receiving an access request, seeking access to a wireless hotspot, from an access seeking entity, where the access request includes an identifier used to authenticate the wireless portable device, checking means for checking the identifier against a database of authorized identifiers and sending means for sending authorization data to the access seeking entity when the identifier is found in the database.

In another embodiment, a system for enabling and controlling access to a wireless hotspot by a wireless portable device is disclosed. The system includes a sender, for sending an access request, seeking access to a wireless hotspot, to an authenticating entity; a timer, for awaiting response to the access request, a provider, for providing additional verification information when requested by the wireless hotspot and an exchanger, for exchanging wireless network data between the wireless portable device and the wireless hotspot. Additionally, the access request includes an identifier used by the authenticating entity to authenticate the wireless portable device.

In another embodiment, a system for enabling and controlling access to a wireless hotspot by a wireless portable device is disclosed. The system includes a receiver, for receiving an access request, seeking access to a wireless hotspot, from an access seeking entity, where the access request includes an identifier used to authenticate the wireless portable device, a checker, for checking the identifier against a database of authorized identifiers, and a sender, for sending authorization data to the access seeking entity when the identifier is found in the database.

These and other objects of the present invention will be described in or be apparent from the following description of the preferred embodiments.

### BRIEF DESCRIPTION OF THE DRAWINGS

For the present invention to be easily understood and readily practiced, preferred embodiments will now be described, for purposes of illustration and not limitation, in conjunction with the following figures:

FIG. 1 is a schematic representation of a wireless telephone system having multiple cells, according to one embodiment of the present invention;

FIG. 2 illustrates a schematic representation of a wireless hotspot with an access point and several wireless devices, according to one embodiment of the present invention;

FIG. 3 illustrates a schematic of a wireless hotspot with connections to different network entities, according to an embodiment of the present invention;

FIG. 4 provides a flowchart of the process of establishing access to a wireless hotspot, according to one embodiment of the present invention;

FIG. 5 provides a flowchart of the process of establishing access to a wireless hotspot, according to one embodiment of the present invention; and

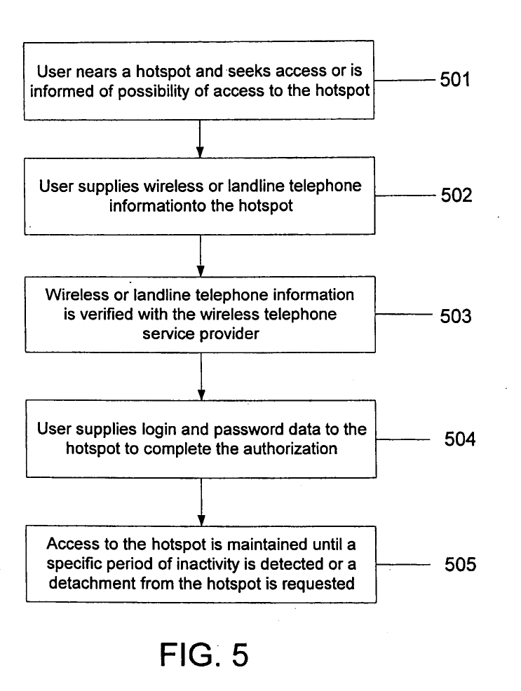

FIG. 6 provides a flowchart of the process of establishing access to a wireless hotspot, according to one embodiment of the present invention.

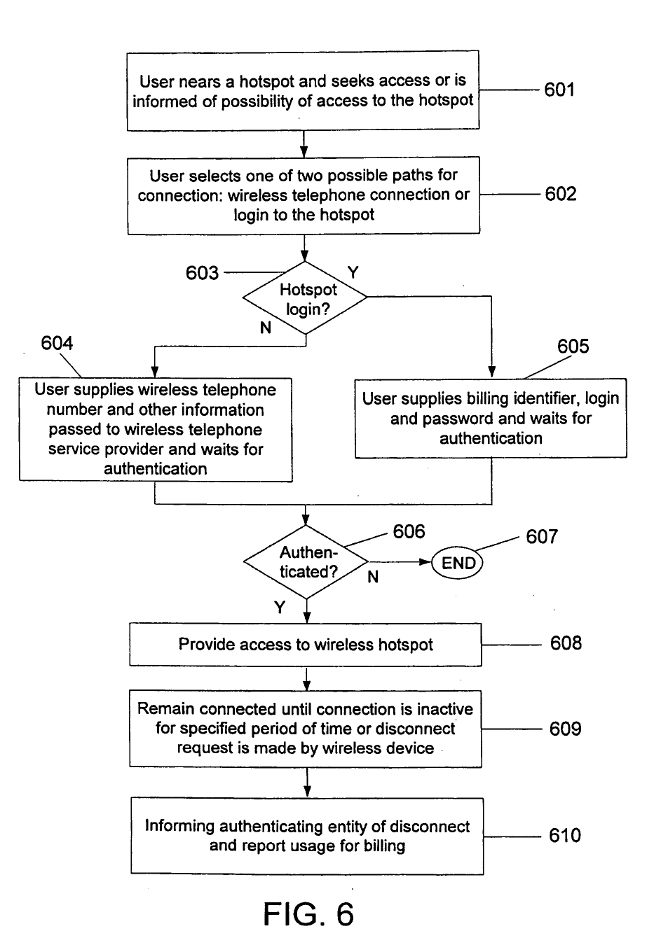

### DETAILED DESCRIPTION OF PREFERRED EMBODIMENTS

The present invention provides, among other things, a benefit of relieving the wireless hotspot establishments from overseeing and controlling the functions of the hotspot. At the same time, because of how the control and access are established, the users may pay for their usage of the hotspot and this also relieves the establishment from the burden of some or all of the cost of providing the wireless hotspot. There are several candidates that can offer these services for the wireless hotspot establishments, as discussed below.

One candidate for offering these services is landline telephone and wireless telephone service providers, where those providers already provide landline, cellular and other wireless telephone data services to their users. Following a similar model as that used for mobile telephones, access to wireless hotspots can be coordinated through wireless or landline telephone service providers, with the wireless or landline telephone service providers assisting in authenticating of users, monitoring of usage, and billing of users. Wireless and landline telephone service providers have WAN backbones that provide network access to the hotspots, with each having its own billing and authorization centers.

Another candidate for offering wireless hotspot services would be a third party that supplies services to the wireless hotspot locations, provides authentication of users and processes and forwards billing information to a billing party. Thus, the third party could provide the interface between the hotspots and an entity with which the user of the hotspot has an account. The entity could be a telephone company or a wireless telephone company or some other service provider.

The present invention provides a system and a method for controlling and enabling access to wireless hotspots. The establishment of access can be performed solely through the use of a wireless telephone connection used in conjunction with an access card used to communicate with the wireless hotspot. Alternatively, the establishment of access can be performed without the use of a wireless telephone through a login to the wireless access point of the hotspot. Additionally, the establishment of access can be performed through authentication with a landline telephone service provider through a login to the wireless access point of the hotspot. In addition, the establishment of access can be administered by a third party, which acts as an agent for a service provider, where the user would have an established account with the third party. Also, the establishment of wireless access can also be through a point of sale, i.e. where a user makes a purchase from the proprietor of the hotspot location and receives wireless access because of that purchase. Combinations of these establishment methods can also be used to enable access to the wireless hotspot.

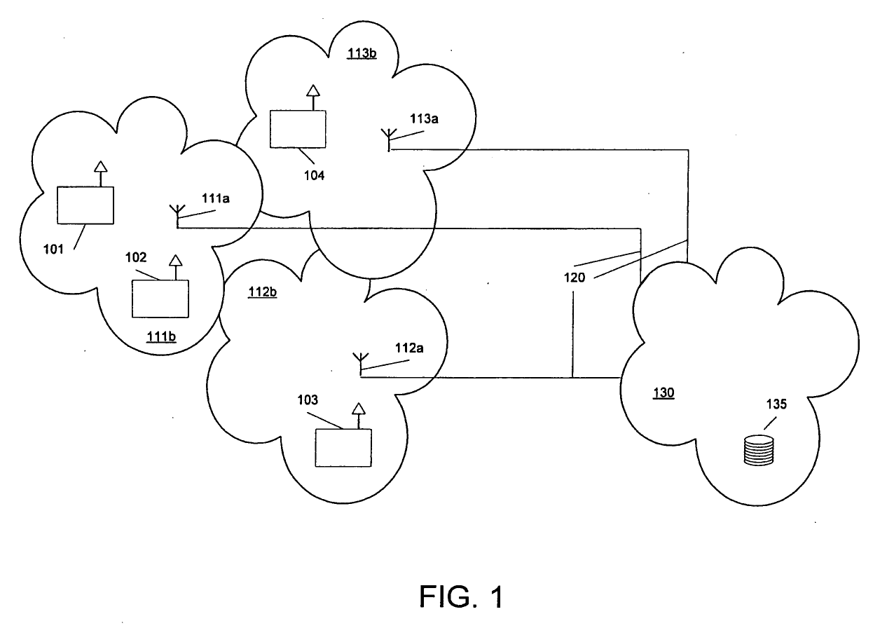

A general cellular telephone network is illustrated in FIG. 1. Multiple cells 111b, 112b and 113b are established through the use of antennas 111a, 112a and 113a. Devices 101-104 having access to the cellular telephone network are able to move from cell to cell and maintain access with the network. Each antenna 111a-113a has a connection, through the link 120, with a service provider 130. The service provider 130 controls access to the network and coordinates the handing-off of access as the devices pass between the cells. The service provider identifies each device and routes communication to the proper location of the particular device. Commonly, the devices 101-104 may be cellular telephones, computers with wireless modems and/or other devices that exchange information with the service provider.

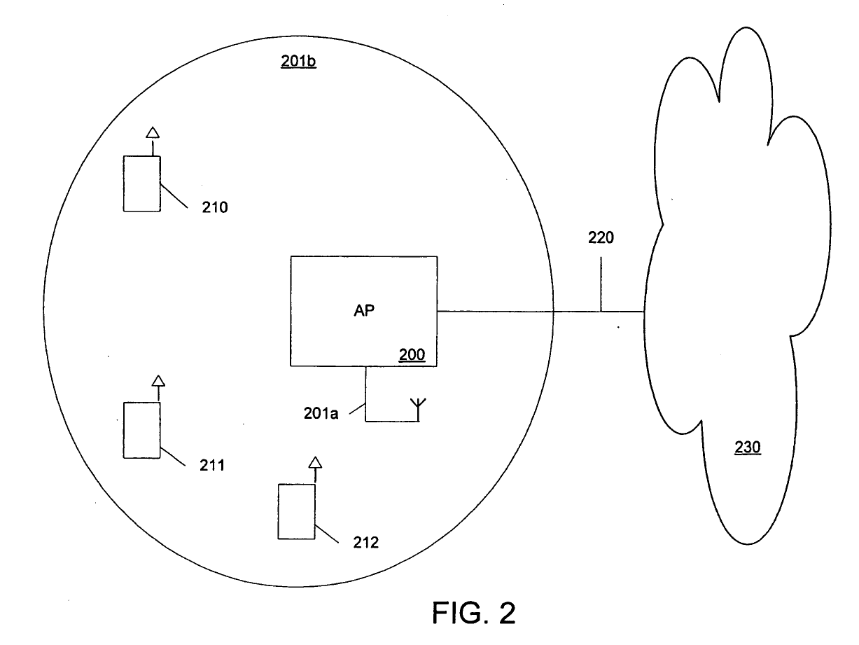

A general wireless hotspot installation is illustrated in FIG. 2. The hotspot is controlled through an access point 200, with the access point having an antenna 201a to establish a wireless access zone 201b. The wireless access may be made through an IEEE 802.11 standard local area network (LAN) or some other type of wireless network. Devices 210-212 within the hotspot are able to communicate with the larger network 230 through communication with the access point 200. The access point 200 has a communication link 220 with the larger network 230 and the access point acts to mediate communication between the devices 210-212 and the larger network and between the devices themselves. As examples, the devices 210-212 may be computers equipped with 802.11 access cards, personal data assistants enabled for wireless access and cellular telephones having multiple means for wireless access. The larger network may be, for example, the Internet or a private wide area network.

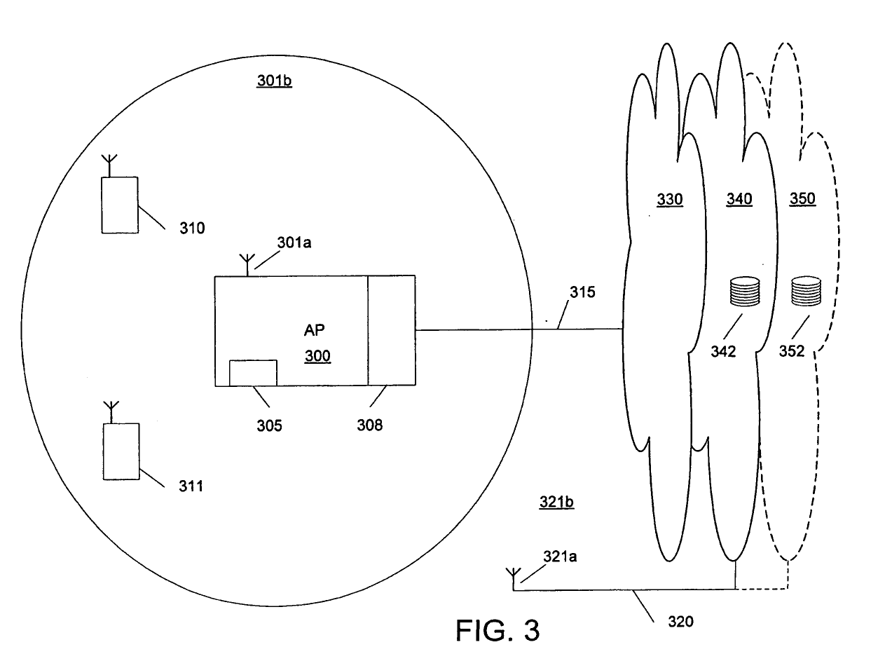

FIG. 3 illustrates one embodiment of the present invention. A wireless hotspot is illustrated, with the coverage of the hotspot set by the access point 300 through an antenna 301a, the range of the hotspot is illustrated by the range 301b. Devices 310 and 311 within the range 301b may potentially establish a connection with the hotspot. The access to the access point is controlled through the access controller 305, that may be hardware, firmware, software or a combination thereof. A communication connection 315 is established between the access point 300 and the larger network 330 where traffic is modulated by a router 308.

Also illustrated in FIG. 3 is a wireless telephone service provider 340. The service provider 340 contains a database 342 of users of the wireless telephone network. The wireless telephone service provider provides services through an antenna 321a, through a connection 320, to provide a coverage area 321b. The coverage area 321b for the wireless telephone service may also include some or all of the wireless hotspot range 301b.

In another embodiment of the present invention, a third party would act as an agent for the service provider and would create the incentive for establishing the hotspot locations. In this embodiment, the service provider, such as a wireless telephone provider 350 would have account information for the user in its database 352. The third party company 340 would act as a go-between and would maintain its own records of users in its own database 342. The benefit of the third party company in this embodiment of the present invention is that the company would provide the interface between the wireless hotspot and the service provider and would not require any direct interaction between the service provider and the wireless hotspot. Another benefit of the third party company embodiment is that users could supply account data for accounts they have with entities other than the wireless telephone service provider, such as a television cable company or an Internet service provider.

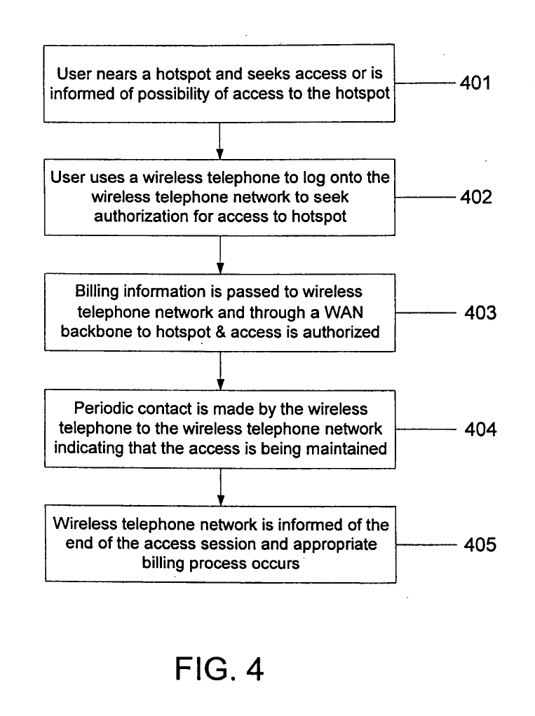

The process of enabling and controlling access to a hotspot according to one embodiment of the present invention is illustrated in FIG. 4. First, a user nears a hotspot and seeks access to the hotspot or is informed of the possibility of access to the hotspot through a query from or advertising by the hotspot, in step 401. The advertising of the wireless hotspot can also be achieved through advertisements received by a wireless telephone, wireless modem, or other wireless networking services enabled in the wireless portable device. In one embodiment, the user can use a wireless telephone or other device to log onto the wireless telephone network to seek authorization for access, in step 402. The data sent to the wireless telephone network may be as simple as a “ping” or other signal indicating the presence of the wireless telephone. Billing information is also passed to the wireless telephone network and through a WAN backbone to hotspot, in step 403, and the authorization of access is provided if the billing information is appropriate. The billing information may be the telephone number of the wireless telephone and the wireless telephone network may simply verify that the number is legitimate and that it can be used to authorize access to the hotspot. Authorization occurs when authorization information is received by the access point of the hotspot from the wireless telephone network.

The authorization process involves the transfer of different types of data between the wireless hotspot and the wireless portable device. The wireless portable device attempts to associate itself with the hotspot through the use of an attach request. Thereafter, public keys or other information are exchanged between the wireless device and the hotspot and account information is sent to a service provider to establish the billing process. In general, the wireless device initially sends an identifier and a public key to the wireless hotspot. The wireless hotspot utilizes the connection with a trusted party, such as the wireless or landline telephone service provider, to verify whether the identifier and public key are correct. The identifier may be a wireless telephone number to provide proper authorization. The wireless hotspot may issue a challenge to the wireless device to seek further verification. The issuing of a challenge may be performed instead of seeking confirmation of authorization data from the trusted party. Additionally, the wireless device may send a public key certificate, which is temporary, and thereafter use symmetric, exchanged keys to ensure proper encryption of data transferred between the wireless device and the wireless hotspot.

As the use of the hotspot continues, periodic contact may be made by the wireless telephone to the wireless telephone network indicating that the access is being maintained, in step 404. Once the access session has ended, the wireless telephone network is informed and the appropriate billing process occurs, in step 405. In the embodiment discussed above, even if a third party provides an interface between the hotspot and the wireless telephone network, the process bypasses the third party except for reporting of the authorization to the access point. This interaction with the third party can also be eliminated if the access point can receive an authorization from the wireless device itself.

An alternate embodiment of the present invention does not require the use of the wireless telephone network alone. Instead the user interacts solely with the hotspot and supplies an identifier for billing. As a user nears a hotspot, the user seeks access to the hotspot or is informed of the possibility of access to the hotspot through a query from or advertising by the hotspot, in step 501. The user then supplies verification information, in step 502, where that verification information may be a wireless or landline telephone number or a wireless or landline telephone network account number. The verification information is verified by the wireless telephone network, in step 503, and the user is then prompted to supply login and password data to the hotspot to complete the authorization process. At this time, the user and the hotspot can exchange information such as public encryption keys and the wireless device can receive data about the hotspot capabilities. The latter capabilities can include the number of users logged on to the hotspot, the expected bandwidth for connected devices. Access to the hotspot can be maintained until a specific period of inactivity is detected or a detachment request is made by either the hotspot or the wireless device.

In an additional embodiment, both pathways to enable access to the hotspot may be employed. Such a process can be helpful because either pathway could fail in the authorization process and the remaining pathway would still allow for access. As a user nears a hotspot, the user seeks access to the hotspot or is informed of the possibility of access to the hotspot through a query from or advertising about the hotspot, in step 601. The user is given a choice of the two possible paths to enable access: via wireless telephone connection or through direct login to the hotspot, in step 602. If the hotspot login process is selected, in step 603, the user is prompted to supply a billing identifier and login and password information and waits for authentication, in step 605. If the wireless telephone connection process is selected, the user supplies their wireless telephone information to the wireless telephone service provider and waits for authorization, in step 604. As discussed above, this process sending the wireless telephone information may be accomplished by establishing a brief connection with the wireless telephone service provider.

If the user's wireless device is authenticated, in step 606, access to the wireless hotspot is provided, in step 608. If no authorization is obtained, the access process is terminated, in step 607. The access connection is monitored until the connection remains inactive for a specified period of time or a disconnect request is received, in step 609. After the access session has ended, the authenticating entity is informed of the disconnection and the usage billing information to passed on the authenticating entity, in step 610.

It would also be within the scope of the invention to implement the disclosed elements of the invention in discrete electronic components, thereby taking advantage of the functional aspects of the invention. Additionally, the present invention can be implemented totally or partially through software.

It is noted that the present application is directed, at least in part, to wireless hotspots. The use of the term wireless hotspot or hotspot is applicable to any wireless access point. The term wireless hotspot or hotspot, as used in the specification and claims, should not be construed to be limited to a single type of locale or be construed as providing access according to only a particular wireless access format, such as the IEEE 802.11 standard. It would also be within the scope of the invention to implement the disclosed elements of the invention in discrete electronic components, thereby taking advantage of the functional aspects of the invention. Additionally, the present invention can be implemented totally or partially through software.

Although the invention has been described based upon these preferred embodiments, it would be apparent to those of skilled in the art that certain modifications, variations, and alternative constructions would be apparent, while remaining within the spirit and scope of the invention. In order to determine the metes and bounds of the invention, therefore, reference should be made to the appended claims.

1. A process of billing for access to and use of a wireless hotspot by a portable device, said process comprising:
supplying account information to an access providing entity;
awaiting a billing authorization from the access providing entity; and
exchanging data with a wireless hotspot by the portable device when the billing authorization is received from the access providing entity,
wherein the account information is used to keep track of charges accrued through the access to and use of the wireless hotspot by the portable device.

2. A process as recited in claim 1, wherein said step of supplying account information comprises supplying the account information to the wireless hotspot.

3. A process as recited in claim 1, wherein said step of supplying account information comprises the supplying account information to a service provider.

4. A process as recited in claim 3, wherein said step of supplying the account information to a service provider comprises supplying the account information to a wireless telephone service provider, wherein the account information is one of a wireless telephone number and a wireless telephone account number.

5. A process as recited in claim 3, wherein said step of supplying the account information to a service provider comprises supplying the account information to a landline telephone service provider, wherein the account information is one of a landline telephone number and a landline telephone account number.

6. A process as recited in claim 1, wherein said step of supplying account information comprises supplying the account information to a third party service provider, wherein the third party service provider receives the account information and transfers data specific to one of a landline telephone service provider, a wireless telephone service provider and an internet service provider, where the specific data is used to keep track of charges accrued through the access to and use of the wireless hotspot by the portable device.

7. A process as recited in claim 1, wherein said step of supplying account information comprises supplying the account information to a wireless telephone service provider through a wireless telephone portion of the portable device.

8. A process as recited in claim 1, wherein said step of supplying account information comprises supplying the account information to a wireless telephone service provider through a wireless telephone that is separate from the portable device.

9. A process as recited in claim 1, wherein said step of exchanging data with the wireless hotspot by the portable device comprises exchanging data with the wireless hotspot by the portable device via at least one of an IEEE 802.11 format, an IEEE 802.15.3 format, a short-range wireless communication standard format and an ultra wideband format.

10. A process of billing for access to and use of a wireless hotspot by a portable device, said process comprising:
requesting account information with the account information being specific to an access providing entity;
receiving authorization information from one of thae portable device and the access providing entity;
authorizing access to a wireless hotspot by the portable device, when the authorization information is determined to authorize access to the wireless hotspot;
exchanging data with the wireless hotspot by the portable device subsequent to authorizing access to the wireless hotspot,
wherein the account information is used to keep track of charges accrued through the access to and use of the wireless hotspot by the portable device.

11. A process as recited in claim 10, wherein said step of receiving authorization information comprises receiving the authorization information from the portable device.

12. A process as recited in claim 10, wherein said step of receiving authorization information comprises receiving the authorization information from a service provider.

13. A process as recited in claim 12, wherein said step of receiving authorization information from a service provider comprises receiving the authorization information from a wireless telephone service provider, wherein the wireless telephone service provider authorizes the portable device based on one of a wireless telephone number and a wireless telephone account number.

14. A process as recited in claim 12, wherein said step of receiving authorization information from a service provider comprises receiving the authorization information from a landline telephone service provider, wherein the landline telephone service provider authorizes the portable device based on one of a landline telephone number and a landline telephone account number.

15. A process as recited in claim 10, wherein said step of receiving authorization information comprises receiving the authorization information from a third party service provider, wherein the third party service provider receives the account information from the portable device and transfers data specific to one of a landline telephone service provider, a wireless telephone service provider and an internet service provider, where the specific data is used to keep track of charges accrued through the access to and use of the wireless hotspot by the portable device.

16. A process as recited in claim 10, wherein said step of receiving authorization information comprises receiving the authorization information from a wireless telephone service provider based on account information received by the wireless telephone service provider through a wireless telephone portion of the portable device.

17. A process as recited in claim 10, wherein said step of receiving authorization information comprises receiving the authorization information from a wireless telephone service provider based on account information received by the wireless telephone service provider through a wireless telephone that is separate from the portable device.

18. A process as recited in claim 10, wherein said step of exchanging data with the wireless hotspot by the portable device comprises exchanging data with the wireless hotspot by the portable device via at least one of an IEEE 802.11 format, an IEEE 802.15.3 format, a short-range wireless communication standard format and an ultra wideband format.

19. A process as recited in claim 10, further comprising:
monitoring the use of the wireless hotspot by the portable device; and
generating billing information related to the monitored use of the wireless hotspot by the portable device.

20. A process as recited in claim 19, further comprising sending the generated billing information to the access providing entity.

21. A process as recited in claim 19, further comprising generating a bill based on the billing information by the wireless hotspot.

22. A billing processor for billing of access to and use of a wireless hotspot by a portable device, said billing processor comprising:
supplying means for supplying account information to an access providing entity;
timing means for awaiting a billing authorization from the access providing entity; and
communication means for exchanging data with a wireless hotspot by a portable device when the billing authorization is received from the access providing entity,
wherein the account information is used to keep track of charges accrued through the access to and use of the wireless hotspot by the portable device.

23. A billing processor as recited in claim 22, wherein said supplying means comprises supplying means for supplying the account information to the wireless hotspot.

24. A billing processor as recited in claim 22, wherein said supplying means comprises supplying means for supplying the account information to a service provider.

25. A billing processor as recited in claim 24, wherein said supplying means comprises supplying means for supplying the account information to a wireless telephone service provider, wherein the account information is one of a wireless telephone number and a wireless telephone account number.

26. A billing processor as recited in claim 24, wherein said supplying means comprises supplying means for supplying the account information to a landline telephone service provider, wherein the account information is one of a landline telephone number and a landline telephone account number.

27. A billing processor as recited in claim 22, wherein said supplying means comprises supplying means for supplying the account information to a third party service provider, wherein the third party service provider receives the account information and transfers data specific to one of a landline telephone service provider, a wireless telephone service provider and an internet service provider, where the specific data is used to keep track of charges accrued through the access to and use of the wireless hotspot by the portable device.

28. A billing processor as recited in claim 22, wherein said supplying means comprises supplying means for supplying account information to a wireless telephone service provider through a wireless telephone portion of the portable device.

29. A billing processor as recited in claim 22, wherein said supplying means comprises supplying means for supplying the account information to a wireless telephone service provider through a wireless telephone that is separate from the portable device.

30. A billing processor as recited in claim 22, wherein said communication means comprises exchanging means for exchanging data with the wireless hotspot by the portable device via at least one of an IEEE 802.11 format, an IEEE 802.15.3 format, a short-range wireless communication standard format and an ultra wideband format.

31. A billing processor for billing of access to and use of a wireless hotspot by a portable device, said billing processor comprising:
requesting means for requesting account information with the account information being specific to an access providing entity;
receiving means for receiving authorization information from one of a portable device and the access providing entity;
authorizing means for authorizing access to a wireless hotspot by the portable device, when the authorization information is determined to authorize access to the wireless hotspot;
communications means for exchanging data with the wireless hotspot by the portable device subsequent to authorizing access to the wireless hotspot,
wherein the account information is used to keep track of charges accrued through the access to and use of the wireless hotspot by the portable device.

32. A billing processor as recited in claim 31, wherein said receiving means comprises receiving means for receiving the authorization information from the portable device.

33. A billing processor as recited in claim 31, wherein said receiving means comprises receiving means for receiving the authorization information from a service provider.

34. A billing processor as recited in claim 33, wherein said receiving means comprises receiving means for receiving the authorization information from a wireless telephone service provider, wherein the wireless telephone service provider authorizes the portable device based on one of a wireless telephone number and a wireless telephone account number.

35. A billing processor as recited in claim 33, wherein said receiving means comprises receiving means for receiving authorization information from a landline telephone service provider, wherein the landline telephone service provider authorizes the portable device based on one of a landline telephone number and a landline telephone account number.

36. A billing processor as recited in claim 31, wherein said receiving means comprises receiving means for receiving the authorization information from a third party service provider, wherein the third party service provider receives the account information from the portable device and transfers data specific to one of a landline telephone service provider, a wireless telephone service provider and an internet service provider, where the specific data is used to keep track of charges accrued through the access to and use of the wireless hotspot by the portable device.

37. A billing processor as recited in claim 31, wherein said receiving means comprises receiving means for receiving the authorization information from a wireless telephone service provider based on account information received by the wireless telephone service provider through a wireless telephone portion of the portable device.

38. A billing processor as recited in claim 31, wherein said receiving means comprises receiving means for receiving the authorization information from a wireless telephone service provider based on account information received by the wireless telephone service provider through a wireless telephone that is separate from the portable device.

39. A billing processor as recited in claim 31, wherein said communication means comprises exchanging means for exchanging data with the wireless hotspot by the portable device via at least one of an IEEE 802.11 format, an IEEE 802.15.3 format, a short-range wireless communication standard format and an ultra wideband format.

40. A billing processor as recited in claim 31, further comprising:
monitoring means for monitoring the use of the wireless hotspot by the portable device; and
generating means for generating billing information related to the use of the wireless hotspot by the portable device.

41. A billing processor as recited in claim 40, further comprising second sending means for sending the billing information to the access providing entity.

42. A billing processor as recited in claim 40, further comprising generating means for generating a bill based on the billing information by the wireless hotspot.

43. A billing processor for billing of access to and use of a wireless hotspot by a portable device, said billing processor comprising:
a first supplier for supplying account information to an access providing entity;
a timer for awaiting a billing authorization from the access providing entity; and
a communicator for exchanging data with a wireless hotspot by a portable device when the billing authorization is received from the access providing entity,
wherein the account information is used to keep track of charges accrued through the access to and use of the wireless hotspot by the portable device.

44. A billing processor as recited in claim 43, wherein said first supplier comprises a second supplier for supplying the account information to the wireless hotspot.

45. A billing processor as recited in claim 43, wherein said first supplier comprises a second supplier for supplying the account information to a service provider.

46. A billing processor as recited in claim 45, wherein said second supplier comprises a third supplier for supplying the account information to a wireless telephone service provider, wherein the account information is one of a wireless telephone number and a wireless telephone account number.

47. A billing processor as recited in claim 45, wherein said second supplier comprises a third supplier for supplying the account information to a landline telephone service provider, wherein the account information is one of a landline telephone number and a landline telephone account number.

48. A billing processor as recited in claim 43, wherein said first supplier comprises a second supplier for supplying the account information to a third party service provider, wherein the third party service provider receives the account information and transfers data specific to one of a landline telephone service provider, a wireless telephone service provider and an internet service provider, where the specific data is used to keep track of charges accrued through the access to and use of the wireless hotspot by the portable device.

49. A billing processor as recited in claim 43, wherein said first supplier comprises a second supplier for supplying the account information to a wireless telephone service provider through a wireless telephone portion of the portable device.

50. A billing processor as recited in claim 43, wherein said first supplier comprises a second supplier for supplying the account information to a wireless telephone service provider through a wireless telephone that is separate from the portable device.

51. A billing processor as recited in claim 43, wherein said communicator comprises an exchanger for exchanging data with the wireless hotspot by the portable device via at least one of an IEEE 802.11 format, an IEEE 802.15.3 format, a short-range wireless communication standard format and an ultra wideband format.

52. A billing processor for billing of access to and use of a wireless hotspot by a portable device, said billing processor comprising:
a requester for requesting account information with the account information being specific to an access providing entity;
a receiver for receiving authorization information from one of a portable device and the access providing entity;
an authorizer for authorizing access to a wireless hotspot by the portable device, when the authorization information is determined to authorize access to the wireless hotspot; and
a communicator for exchanging data with the wireless hotspot by the portable device subsequent to authorizing access to the wireless hotspot,
wherein the account information is used to keep track of charges accrued through the access to and use of the wireless hotspot by the portable device.

53. A billing processor as recited in claim 52, wherein said receiver is configured to receive the authorization information from the portable device.

54. A billing processor as recited in claim 52, wherein said receiver is configured to receive the authorization information from a service provider.

55. A billing processor as recited in claim 54, wherein said receiver is configured to receive the authorization information from a wireless telephone service provider, wherein the wireless telephone service provider authorizes the portable device based on one of a wireless telephone number and a wireless telephone account number.

56. A billing processor as recited in claim 54, wherein said receiver is configured to receive the authorization information from a landline telephone service provider, wherein the landline telephone service provider authorizes the portable device based on one of a landline telephone number and a landline telephone account number.

57. A billing processor as recited in claim 52, wherein said receiver is configured to receive the authorization information from a third party service provider, wherein the third party service provider receives the account information from the portable device and transfers data specific to one of a landline telephone service provider, a wireless telephone service provider and an internet service provider, where the specific data is used to keep track of charges accrued through the access to and use of the wireless hotspot by the portable device.

58. A billing processor as recited in claim 52, wherein said receiver is configured to receive the authorization information from a wireless telephone service provider based on account information received by the wireless telephone service provider through a wireless telephone portion of the portable device.

59. A billing processor as recited in claim 52, wherein said receiver is configured to receive authorization information from a wireless telephone service provider based on account information received by the wireless telephone service provider through a wireless telephone that is separate from the portable device.

60. A billing processor as recited in claim 52, wherein said communicator comprises an exchanger for exchanging data with the wireless hotspot by the portable device via at least one of an IEEE 802.11 format, an IEEE 802.15.3 format, a short-range wireless communication standard format and an ultra wideband format.

61. A billing processor as recited in claim 52, further comprising:
a monitor for monitoring the use of the wireless hotspot by the portable device; and
a generator for generating billing information related to the use of the wireless hotspot by the portable device.

62. A billing processor as recited in claim 61, further comprising another sender for sending the billing information to the access providing entity.

63. A billing processor as recited in claim 61, further comprising a bill generator for generating a bill based on the billing information by the wireless hotspot.
